(19) United States
(12) Patent Application Publication
(10) Pub. No.: US 2024/0418903 A1
(43) Pub. Date: Dec. 19, 2024

(54) Identifying Geological Features Based on Gravity Anomalies

(71) Applicant: Saudi Arabian Oil Company, Dhahran (SA)

(72) Inventors: Asif Muzaffar, Dhahran (SA); Goutam Kumar Nayak, Dhahran (SA)

(21) Appl. No.: 18/335,303

(22) Filed: Jun. 15, 2023

(51) Int. Cl. G01V 7/04; E21B 44/00; E21B 49/00

(52) U.S. Cl. CPC G01V 7/04; E21B 44/00; E21B 49/00; G01V 1/30; G01V 7/06; G01V 11/00; E21B 2200/20

(57) ABSTRACT

Methods and systems for geophysical exploration include accessing, from a data store, measured gravity values for a geographical area; modeling gravity values for the geographical area; determining gravity anomaly values based on the measured gravity values and the modeled gravity values; A gravity anomaly map of the geographical area is generated based on the determined gravity anomaly values and physical locations in the geographical area associated with the determined gravity anomaly values. A dip surface is generated representing inclinations of the geographical area based on the gravity anomaly map. A gravity dip map of the geographical area is generated by combining the dip surface with the gravity anomaly map, and a visual representation of the gravity dip map of the geographical area is displayed, on a display device, wherein colors of the visual representation represent the values of the gravity map.

### TECHNICAL FIELD

The present disclosure relates to geophysical exploration of a subterranean formation.

### BACKGROUND

The rugged surface of the Earth and non-uniform composition of the Earth's crust cause gravity variations across the surface of the Earth. Theoretical models can be used to predict distortion of the gravity field based on a known topography of the surface; however, this modeling does not capture distortions resulting from non-uniform subterranean formations. Gravity values at locations on the surface can also be measured. Differences between the measured values of gravity and values of gravity predicted by a theoretical Earth model are known as gravity anomalies. Gravity anomalies can be used in geophysical exploration of subterranean formations, for example, in the oil and gas industry, to identify locations that may contain hydrocarbons.

### SUMMARY

This disclosure describes methods and systems for identifying geological features of a subterranean formation based on gravity anomaly values. A data processing system, such as a control system or computer, accesses measured gravity values for a geographical area from a data store. The data processing system models gravity values for the geographical area. The data processing system determines gravity anomaly values based on the measured gravity values and the modeled gravity values. The data processing system generates a gravity anomaly map of the geographical area based on the determined gravity anomaly values. The data processing system generates a dip surface representing inclinations of the geographical area based on the gravity anomaly map. The data processing system generates a gravity dip map of the geographical area by combining the dip surface with the gravity anomaly map, and the data processing system displays a visual representation of the gravity dip map on a display device.

Implementations of the systems and methods of this disclosure can provide various technical benefits. Conventional methods of interpreting geological structures that include using a gravity anomaly map can require applying dozens of filters (e.g., high pass, band pass, and low pass filters). The filters are applied to the gravity anomaly map to determine derivatives, second derivatives, and tilt of the gravity anomaly maps in vertical and/or horizontal directions.

Conventional methods generate a large amount of data (e.g., generating dozens of maps of the geographical area) with a correspondingly large number of computations. Furthermore, there is a variability regarding the number and types of filters that can be applied to the gravity anomaly map. This variability can cause an inconsistent interpretation of the gravity anomaly map. The resulting data from applying these filters is too inconsistent for detailed or small-scale lineament picking, such as picking structural geographic features smaller than large scale faults, dikes, or other large linear structural features. Further, the results of the interpretation from applying these filters to the gravity anomaly map may not agree with data from a different source, such as seismic data.

To overcome these technical challenges, the systems and methods of this disclosure use less data (e.g., generating two maps) and fewer computations as compared with conventional methods. The data processing system generates a dip surface and identifies areas of maximum curvature without applying the dozens of filters of the conventional methods. The dip surface represents inclination of the geographical region and provides a sense of high and low geological structures. The data processing system generates a high-resolution map with resolution of features at the length scale of the grid spacing including detailed structural lineaments and relative structural relief information using less data and fewer computations than conventional methods. The data processing system generates the map without parameter adjustment reducing errors and dependence on the skill level of the interpreter. The data processing system generates the map on the in minutes as compared with applying numerous filters that can take hours.

The generated map can identify faults of the subterranean formation for interpretation, basement block movement, and deformation in the upper layers of the subterranean formation, which are useful for field scale stress analysis and full-scale plate tectonics analysis. The generated map can specify precise locations (on the order of the grid resolution of the gravity anomaly map) that identify reservoir delineation or extension and exploration targets. The map identifies subterranean structures useful for carbon sequestration projects and areas of interest for future seismic surveys in the geographical area.

The generated map can guide the placement of well locations for newly drilled wells. The generated map can also guide the placement of seismic receiver arrays. For example, the data processing system can determine locations to drill wells based on features identified in the generated map. The data processing system can generate control commands to control remote drilling equipment.

In one aspect, a method for geophysical exploration includes accessing, from a data store, measured gravity values for a geographical area; modeling gravity values for the geographical area; determining gravity anomaly values based on the measured gravity values and the modeled gravity values; generating a gravity anomaly map of the geographical area based on the determined gravity anomaly values and physical locations in the geographical area associated with the determined gravity anomaly values; generating a dip surface representing inclinations of the geographical area based on the gravity anomaly map; generating a gravity dip map of the geographical area by combining the dip surface with the gravity anomaly map; and displaying, on a display device, a visual representation of the gravity dip map of the geographical area where colors of the visual representation represent the values of the gravity map.

In one aspect, a system for geophysical exploration includes at least one processor; and a memory storing instructions that, when executed by the at least one processor, cause the at least one processor to perform operations including accessing, from a data store, measured gravity values for a geographical area; modeling gravity values for the geographical area; determining gravity anomaly values based on the measured gravity values and the modeled gravity values; generating a gravity anomaly map of the geographical area based on the determined gravity anomaly values and physical locations in the geographical area associated with the determined gravity anomaly values; generating a dip surface representing inclinations of the geographical area based on the gravity anomaly map; generating a gravity dip map of the geographical area by combining the dip surface with the gravity anomaly map; and displaying, on a display device, a visual representation of the gravity dip map of the geographical area where colors of the visual representation represent the values of the gravity map.

In one aspect, one or more non-transitory machine-readable storage devices storing instructions for geophysical exploration, the instructions being executable by one or more processors, to cause performance of operations including accessing, from a data store, measured gravity values for a geographical area; modeling gravity values for the geographical area; determining gravity anomaly values based on the measured gravity values and the modeled gravity values; generating a gravity anomaly map of the geographical area based on the determined gravity anomaly values and physical locations in the geographical area associated with the determined gravity anomaly values; generating a dip surface representing inclinations of the geographical area based on the gravity anomaly map; generating a gravity dip map of the geographical area by combining the dip surface with the gravity anomaly map; and displaying, on a display device, a visual representation of the gravity dip map of the geographical area where colors of the visual representation represent the values of the gravity map.

Implementations of these aspects can include one or more of the following features.

In some implementations, these aspects include determining a location within the geographical area to drill a well based on the gravity dip map; and generating control commands to control remote drilling equipment to drill the well.

In some implementations, these aspects include identifying locations of maximum curvature of the dip surface; and generating a visual representation of lineaments of the geographical area based on the gravity dip map and the identified locations of maximum curvature of the dip surface.

In some implementations, these aspects include determining locations within the geographical area to perform seismic exploration measurements based on the gravity dip map and the identified locations of maximum curvature.

In some implementations, generating the gravity dip map is independent from applying high pass, band pass and low pass filters to the gravity anomaly map.

In some implementations, generating a dip surface includes scaling the gravity anomaly values based on a desired range of dip angles.

In some implementations, the gravity anomaly values represent Bouguer gravity anomaly values.

The details of one or more embodiments of these systems and methods are set forth in the accompanying drawings and the description below. Other features, objects, and advantages of these systems and methods will be apparent from the description and drawings, and from the claims.

### DESCRIPTION OF DRAWINGS

The patent or application file contains at least one drawing executed in color. Copies of this patent or patent application publication with color drawing(s) will be provided by the Office upon request and payment of the necessary fee.

FIG. 1 is a flow chart of an example method for identifying geological features based on a gravity anomaly.

FIG. 2 is an example gravity anomaly map.

FIG. 3 is an example dip surface based on the gravity anomaly map of FIG. 2.

FIG. 4A-4B illustrate examples of combined gravity anomaly maps and dip surfaces of FIGS. 2-3 with identified geological structures and interpretation.

FIG. 5 is a schematic of example curvatures of a line.

FIG. 6A-6D illustrate example maps of maximum curvature combined with the map of FIG. 4A showing detailed lineaments of the geographical area.

FIG. 7A-7B illustrate example comparisons between the map of FIG. 4A and seismic data.

FIG. 8 is a block diagram illustrating an example computer system used to provide computational functionalities associated with described algorithms, methods, functions, processes, flows, and procedures according to some implementations of the present disclosure.

Like reference symbols in the various drawings indicate like elements.

### DETAILED DESCRIPTION

This specification describes methods and systems for identifying geological structures in a subterranean formation based on gravity anomalies. A data processing system (e.g., a computer or control system) accesses measured gravity values for a geographical area of interest. The data processing system models gravity values for the geographical area. The data processing system determines gravity anomaly values based on the measured gravity values and the modeled gravity values. The data processing system generates a gravity anomaly map based on the determined values and physical locations associated with the gravity anomaly values. The data processing system generates a dip surface representing inclinations of the geographical area based on the gravity anomaly map. The data processing system generates a gravity dip map of the geographical area by combining the dip surface with the gravity anomaly map. The data processing system displays a visual representation of the gravity dip map on a display device with the colors of the visual representation representing the values of the gravity dip map.

The data processing system can determine locations for further exploration based on the gravity dip map. The data processing system can determine locations to drill wells based on locations in the gravity dip map that are consistent with geological features that hold hydrocarbons. The data processing system can generate control commands to operate the drilling equipment to drill the well. In some implementations, the data processing system determines locations to place seismic receivers for seismic exploration of the subterranean formation.

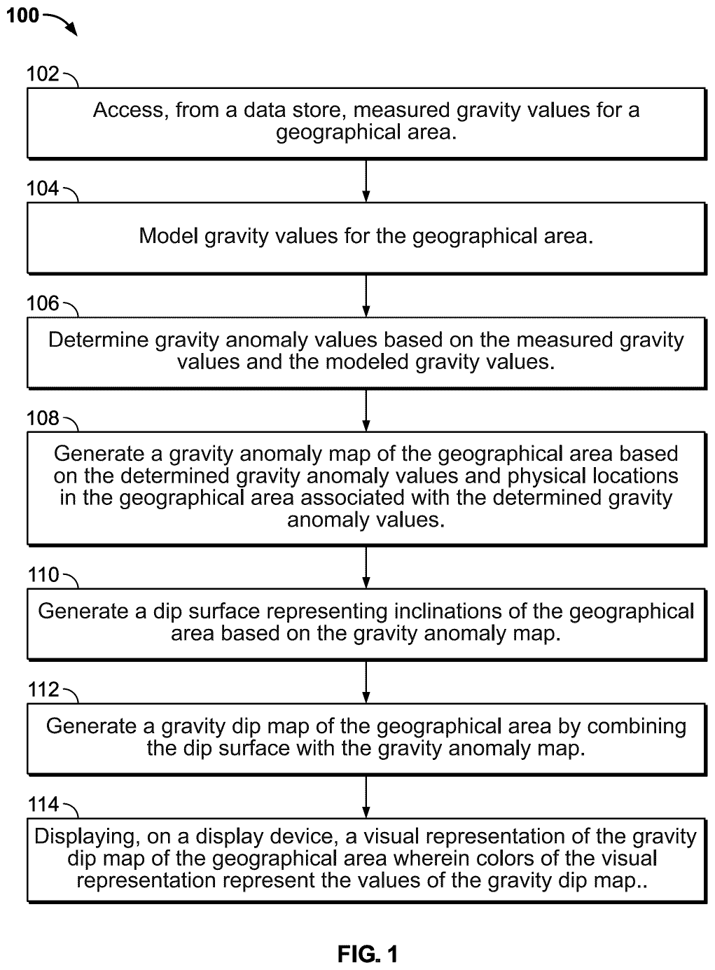

FIG. 1 is a flow chart of an example method 100 of identifying geological features in a subterranean formation based on gravity anomalies. A gravity anomaly represents a difference between a theoretical or modeled value of gravity at a location and a measured value of gravity at that location. The magnitude of the gravity anomaly can depend on the composition of the rocks in the subterranean formation beneath the location. Other factors that can affect the magnitude of the gravity anomaly include, for example, the latitude of the location and the elevation of the location.

A data processing system accesses measured gravity values from a data store for a target geographical area (step 102). The gravity values can be measured, for example, by a gravimeter, which is an instrument designed to measure local values of gravitational acceleration of objects in free-fall.

The data processing system models gravity values for the geographical area (step 104). The modeling can be based on an idealized shape and rotation of the Earth, and correction factors to the idealized shape can be applied. For example, the data processing system can model the gravity values with correction factors based on known topography, elevation, and/or latitude. In some implementations, the data processing system accesses previously modeled gravity values from a data store.

The data processing system determines gravity anomaly values for the geographical area based on the measured gravity values and the modeled gravity values (step 106). The type of gravity anomaly determined depends on the model used by the data processing system to model the gravity values. For example, if the data processing system includes a free-air correction in the modeling, the gravity anomaly is a free-air anomaly. If the data processing system additionally includes a Bouguer plate correction, which accounts for gravitational attraction of a layer of material outside the reference ellipsoid of the Earth model, then the gravity anomaly is a Bouguer gravity anomaly. The Bouguer gravity anomaly can be determined by subtracting the modeled gravity from the free-air or measured gravity values. The Bouguer gravity anomaly is useful for interpreting geological features of the subsurface.

The data processing system generates a gravity anomaly map of the geographical area based on the determined gravity anomaly values and physical locations associated with the determined gravity anomaly values (step 108). The data processing system can generate the gravity anomaly map as a 3D surface where X and Y coordinate represent the location and the Z coordinate represents the gravity anomaly value.

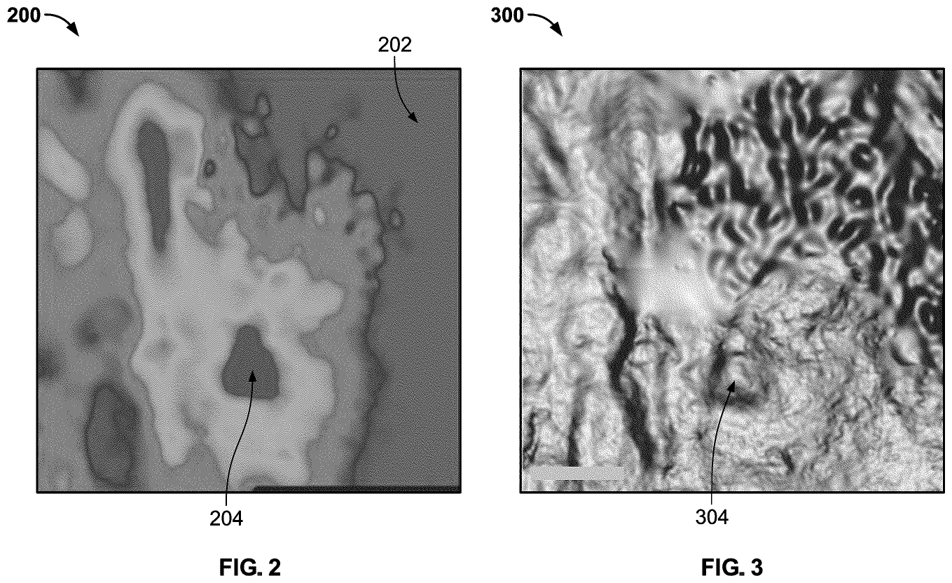

FIG. 2 shows an example Bouguer gravity anomaly map 200 of a target geographical area. The colors or grayscale intensities represent the values of the gravity anomaly. Variations in the gravity anomaly indicate variations in the density of the subsurface. The gravity anomaly map yields insight to the geological structure of the subterranean formation. For example, the region 202 has a lower gravity anomaly value than the region 204. This can indicate that the rock in the subsurface of region 202 has a lower density than the rock in the subsurface of region 204. The gravity anomaly map alone does not indicate topography or surface features. The grid spacing of the gravity anomaly map 200 is 1 km.

Turning back to FIG. 1, the data processing system generates a dip surface representing inclinations of the geographical area based on the gravity anomaly map (step 110). In some implementations, the values of the gravity anomaly are small in comparison to the length scales of the location axes. The data processing system can scale the values of the gravity anomaly to obtain a desired range of dip angles. For example, the data processing system can scale the gravity anomaly values by a factor of one thousand to obtain dip angles in a range between 0 and 45 degrees.

For example, the data processing system can determine dip as:

$$Dip = \frac{1}{2} ( {tan}^{- 1} ( mod ( Δ g / Δ x ) ) + {tan}^{- 1} ( mod ( Δ g / Δ y ) ) ) ,$$

where Δg represents the change in the gravity anomaly value between neighboring points on the map, Δx represents the distance between neighboring points in the X direction, Δy represents the distance between neighboring points in the Y direction. The tan⁻¹(mod(Δg/Δx)) represents the dip in X direction and tan⁻¹ (mod(Δg/Δy)) represents the dip in the Y direction. The modulo operator constrains the dip angle to be in the range of 0°-90°.

FIG. 3 is an example dip surface 300 corresponding to gravity anomaly map 200. The dip surface 300 represents the inclination of the geographic area. For example, region 304 indicates a peak or valley in the formation.

Referring back to FIG. 1, the data processing system generates a gravity dip map by combining the dip surface with the gravity anomaly map (step 112). The data processing system can combine the dip surface and the gravity anomaly map by, for example, overlaying the dip surface with the gravity anomaly map. The data processing system generates the gravity dip map without using high pass, low pass or band pass filters as in the conventional methods. The combination of the gravity anomaly map and dip surface can reveal morphological features of the geographic area such as canyons, escarpments, domes, faults, or other relief features in the subsurface. Deformation envelopes (e.g., areas of deformation) in the sedimentary layers by a basement block movement can also be interpreted.

The data processing system displays a visual representation of the gravity dip map on a display device where colors represent the values of the gravity dip map (step 114). In some implementations, the colors are grayscale intensities. The visual representation can be interactive. For example, the data processing system can zoom in or zoom out and rotate the displayed visual representation to show more or less detail.

The data processing system can determine locations for further exploration of the subterranean formation based on the generated gravity dip maps. For example, the data processing system can determine locations to drill wells based on locations within the gravity dip map that are consistent with geological structures that include hydrocarbons. The data processing system can generate control commands to control remote drilling equipment to drill the wells. Other examples of additional exploration include conducting seismic surveys of the subterranean formation. The data processing system can determine locations for seismic exploration based on the gravity dip map.

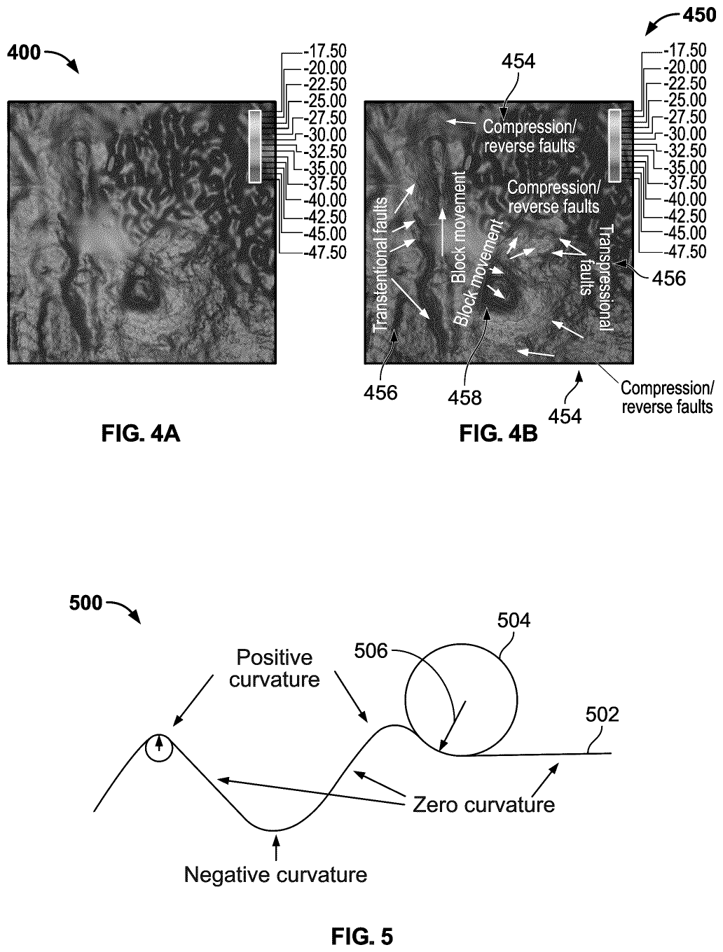

FIG. 4A shows an example visual representation of a gravity dip map 400. The gravity dip map 400 is an overlay of the Bouguer gravity anomaly map 200 on top of the dip surface 300. The gravity dip map visualizes the major geological features of the geographical area of interest. It is a structural map of the area without the true elevations.

FIG. 4B shows another example visual representation of an interpreted gravity dip map 450. The interpreted gravity dip map 450 reveals the geological features, including the nature of the faults, such as compression faults 454, transtensional faults 456 and basement block movements 458. Positive relief structures with closing polygons indicate locations for additional seismic surveys and drilling new wells. Salt domes will appear with negative anomaly values due to low densities, which indicate areas to be verified with seismic data.

In some implementations of the method 100, the data processing system determines locations of maximum curvature of the dip surface. The identification of maximum curvature of the dip surface can enhance the resolution of small-scale lineaments.

FIG. 5 shows a schematic 500 of determining curvature of a line 502. The curvature is defined by deviation of a curve from a straight line at a particular point. For a surface, the curvature is defined as the deviation of the surface from a plane. The path of the line 502 is defined by the osculating circle 504, which is the best fitted circle to the line 502 at a particular point. The radius 506 of the osculating circle at a particular point is called the radius of curvature. The mathematical expression of curvature is given by k(x)=|f″(x)|/[1+ (f′(x))\hat{ }2]\hat{ }3/2, where f′(x) and f″(x) are the first and second derivatives, respectively, of the line f(x).

To find relative maxima of the curvature, the data processing system can determine the first derivative of the curvature function, k′(x). The data processing system determines values where the first derivative is equal to zero k′(x)=0. The data processing system determines the second derivative of the curvature function, k″(x). The data processing system determines that a point is a relative maximum if k′(x)=0 and k″(x) is positive for x−Δx and negative for x+Δx. is negative. Locations of maximum curvature of the dip surface represent regions with sharp changes in the inclination of the subsurface formation. These locations can indicate faults or other lineaments (e.g., linear geological features). Identifying the locations of maximum curvature provides finer details of the subterranean formation than the dip surface and gravity anomaly map alone.

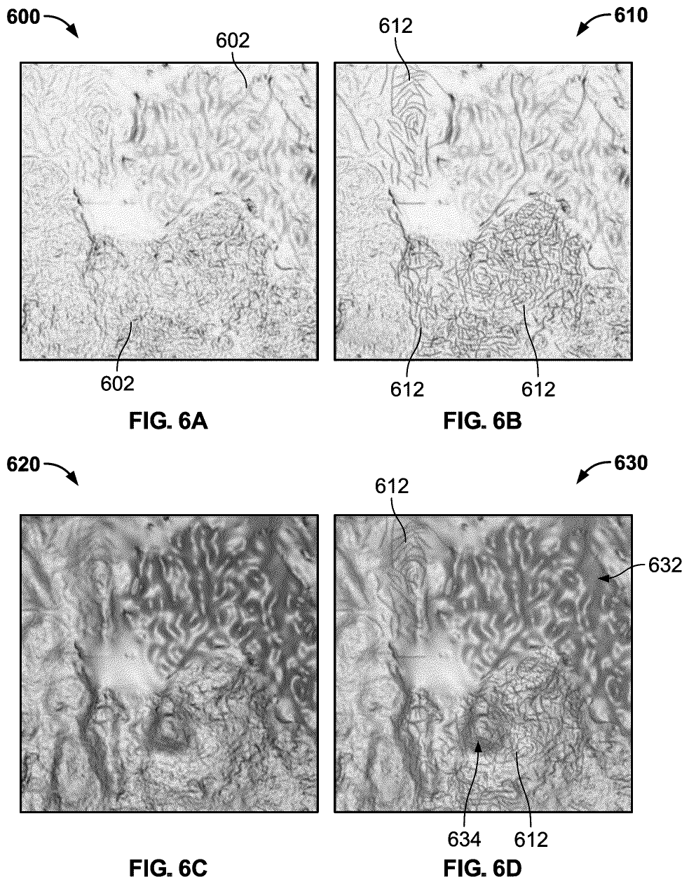

FIGS. 6A-6D illustrate steps in generating a visual representation of the geographical region using the identified location of maximum curvature. FIG. 6A shows an example of a maximum curvature map 600 based on the dip surface 300. The maximum curvature map 600 includes fine details 602 of the geographical area. FIG. 6B shows an example map 610 of the maximum curvature with lineament interpretation 612. FIG. 6C shows an example combination map 620 with the gravity anomaly map 200 overlaying the dip surface 300 and the maximum curvature map 600. FIG. 6D shows another example combination map 630 with the combination map 620 further overlaid with the lineament interpretation 612. The combination map 630 reveals large geological structures 632, inclinations 634 of the geographical area, and fine details of lineaments 612 (e.g., linear geological structures) within the target area. The fine details of the combination map 630 resolve geological features with a length scale of approximately 2 km, which is obtained without parameter adjustment better than the resolution achievable by applying filters to the gravity anomaly map without parameter adjustments.

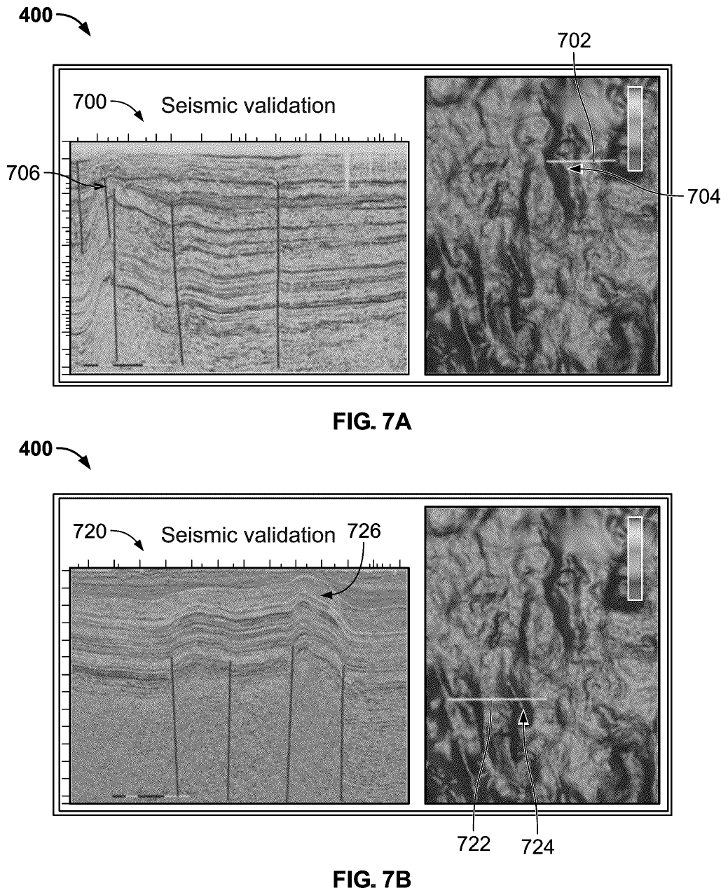

FIGS. 7A-7B illustrate comparisons between the gravity dip map 400 and seismic data acquired at corresponding locations. FIG. 7A shows seismic data 700 corresponding to line 702 from gravity dip map 400. The region 704 indicates an inclined region in the gravity dip map 400. The seismic data 700 confirms this inclination as seen by the raised portion 706 of the seismic data 700. The gravity map provides a representation of features of the subsurface for a large portion of the subsurface. Individual features can be further analyzed using seismic data gathering techniques and/or well-logging techniques.

FIG. 7B shows seismic data 720 corresponding to line 722 from gravity dip map 400. The region 724 indicates an inclined region in the gravity dip map 400. The seismic data 720 validates this inclination as seen by the raised portion 726 of the seismic data 700.

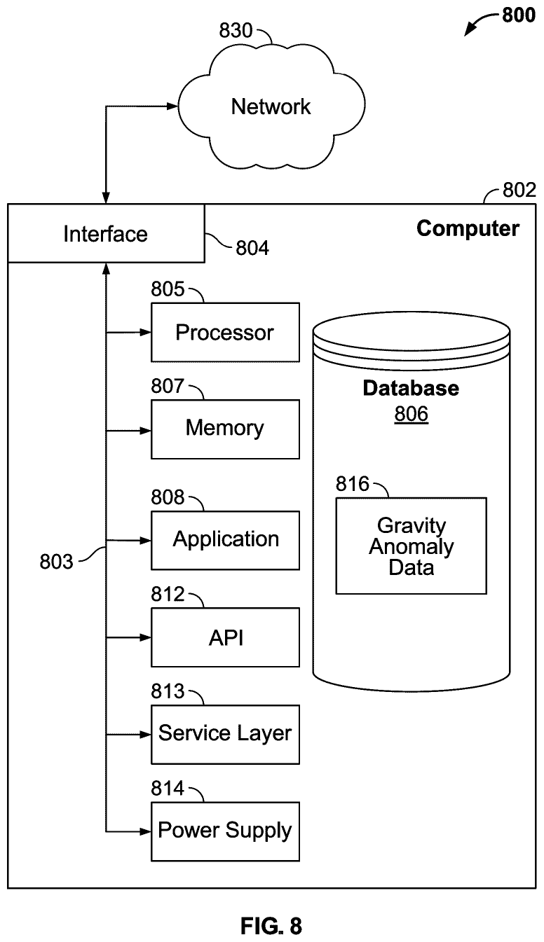

FIG. 8 is a block diagram of an example computer system 800 used to provide computational functionalities associated with described algorithms, methods, functions, processes, flows, and procedures described in the present disclosure, according to some implementations of the present disclosure. The illustrated computer 802 is intended to encompass any computing device such as a server, a desktop computer, a laptop/notebook computer, a wireless data port, a smart phone, a personal data assistant (PDA), a tablet computing device, or one or more processors within these devices, including physical instances, virtual instances, or both. The computer 802 can include input devices such as keypads, keyboards, and touch screens that can accept user information. Also, the computer 802 can include output devices that can convey information associated with the operation of the computer 802. The information can include digital data, visual data, audio information, or a combination of information. The information can be presented in a graphical user interface (UI) (or GUI).

The computer 802 can serve in a role as a client, a network component, a server, a database, a persistency, or components of a computer system for performing the subject matter described in the present disclosure. The illustrated computer 802 is communicably coupled with a network 830. In some implementations, one or more components of the computer 802 can be configured to operate within different environments, including cloud-computing-based environments, local environments, global environments, and combinations of environments.

At a high level, the computer 802 is an electronic computing device operable to receive, transmit, process, store, and manage data and information associated with the described subject matter. According to some implementations, the computer 802 can also include, or be communicably coupled with, an application server, an email server, a web server, a caching server, a streaming data server, or a combination of servers.

The computer 802 can receive requests over network 830 from a client application (for example, executing on another computer 802). The computer 802 can respond to the received requests by processing the received requests using software applications. Requests can also be sent to the computer 802 from internal users (for example, from a command console), external (or third) parties, automated applications, entities, individuals, systems, and computers.

Each of the components of the computer 802 can communicate using a system bus 803. In some implementations, any or all of the components of the computer 802, including hardware or software components, can interface with each other or the interface 804 (or a combination of both), over the system bus 803. Interfaces can use an application programming interface (API) 812, a service layer 813, or a combination of the API 812 and service layer 813. The API 812 can include specifications for routines, data structures, and object classes. The API 812 can be either computer-language independent or dependent. The API 812 can refer to a complete interface, a single function, or a set of APIs.

The service layer 813 can provide software services to the computer 802 and other components (whether illustrated or not) that are communicably coupled to the computer 802. The functionality of the computer 802 can be accessible for all service consumers using this service layer. Software services, such as those provided by the service layer 813, can provide reusable, defined functionalities through a defined interface. For example, the interface can be software written in JAVA, C++, or a language providing data in extensible markup language (XML) format. While illustrated as an integrated component of the computer 802, in alternative implementations, the API 812 or the service layer 813 can be stand-alone components in relation to other components of the computer 802 and other components communicably coupled to the computer 802. Moreover, any or all parts of the API 812 or the service layer 813 can be implemented as child or sub-modules of another software module, enterprise application, or hardware module without departing from the scope of the present disclosure.

The computer 802 includes an interface 804. Although illustrated as a single interface 804 in FIG. 8, two or more interfaces 804 can be used according to particular needs, desires, or particular implementations of the computer 802 and the described functionality. The interface 804 can be used by the computer 802 for communicating with other systems that are connected to the network 830 (whether illustrated or not) in a distributed environment. Generally, the interface 804 can include, or be implemented using, logic encoded in software or hardware (or a combination of software and hardware) operable to communicate with the network 830. More specifically, the interface 804 can include software supporting one or more communication protocols associated with communications. As such, the network 830 or the interface's hardware can be operable to communicate physical signals within and outside of the illustrated computer 802.

The computer 802 includes a processor 805. Although illustrated as a single processor 805 in FIG. 8, two or more processors 805 can be used according to particular needs, desires, or particular implementations of the computer 802 and the described functionality. Generally, the processor 805 can execute instructions and can manipulate data to perform the operations of the computer 802, including operations using algorithms, methods, functions, processes, flows, and procedures as described in the present disclosure.

The computer 802 also includes a database 806 that can hold data for the computer 802 and other components connected to the network 830 (whether illustrated or not). For example, database 806 can be an in-memory, conventional, or a database storing data consistent with the present disclosure. In some implementations, database 806 can be a combination of two or more different database types (for example, hybrid in-memory and conventional databases) according to particular needs, desires, or particular implementations of the computer 802 and the described functionality. Although illustrated as a single database 806 in FIG. 8, two or more databases (of the same, different, or combination of types) can be used according to particular needs, desires, or particular implementations of the computer 802 and the described functionality. While database 806 is illustrated as an internal component of the computer 802, in alternative implementations, database 806 can be external to the computer 802. Database 806 can include gravity anomaly data 816.

The computer 802 also includes a memory 807 that can hold data for the computer 802 or a combination of components connected to the network 830 (whether illustrated or not). Memory 807 can store any data consistent with the present disclosure. In some implementations, memory 807 can be a combination of two or more different types of memory (for example, a combination of semiconductor and magnetic storage) according to particular needs, desires, or particular implementations of the computer 802 and the described functionality. Although illustrated as a single memory 807 in FIG. 8, two or more memories 807 (of the same, different, or combination of types) can be used according to particular needs, desires, or particular implementations of the computer 802 and the described functionality. While memory 807 is illustrated as an internal component of the computer 802, in alternative implementations, memory 807 can be external to the computer 802.

The application 808 can be an algorithmic software engine providing functionality according to particular needs, desires, or particular implementations of the computer 802 and the described functionality. For example, application 808 can serve as one or more components, modules, or applications. Further, although illustrated as a single application 808, the application 808 can be implemented as multiple applications 808 on the computer 802. In addition, although illustrated as internal to the computer 802, in alternative implementations, the application 808 can be external to the computer 802.

The computer 802 can also include a power supply 814. The power supply 814 can include a rechargeable or non-rechargeable battery that can be configured to be either user- or non-user-replaceable. In some implementations, the power supply 814 can include power-conversion and management circuits, including recharging, standby, and power management functionalities. In some implementations, the power-supply 814 can include a power plug to allow the computer 802 to be plugged into a wall socket or a power source to, for example, power the computer 802 or recharge a rechargeable battery.

There can be any number of computers 802 associated with, or external to, a computer system containing computer 802, with each computer 802 communicating over network 830. Further, the terms “client,” “user,” and other appropriate terminology can be used interchangeably, as appropriate, without departing from the scope of the present disclosure. Moreover, the present disclosure contemplates that many users can use one computer 802 and one user can use multiple computers 802.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non transitory, computer-readable computer-storage medium for execution by, or to control the operation of, data processing apparatus. Alternatively, or additionally, the program instructions can be encoded in/on an artificially generated propagated signal. The example, the signal can be a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatus, devices, and machines for processing data, including by way of example, a programmable processor, a computer, or multiple processors or computers. The apparatus can also include special purpose logic circuitry including, for example, a central processing unit (CPU), a field programmable gate array (FPGA), or an application specific integrated circuit (ASIC). In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example LINUX, UNIX, WINDOWS, MAC OS, ANDROID, or IOS.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computer readable media (transitory or non-transitory, as appropriate) suitable for storing computer program instructions and data can include all forms of permanent/non-permanent and volatile/non-volatile memory, media, and memory devices. Computer readable media can include, for example, semiconductor memory devices such as random access memory (RAM), read only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer readable media can also include, for example, magnetic devices such as tape, cartridges, cassettes, and internal/removable disks.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

A number of embodiments of these systems and methods have been described. Nevertheless, it will be understood that various modifications may be made without departing from the spirit and scope of this disclosure. Accordingly, other embodiments are within the scope of the following claims.

What is claimed is:

1. A method for geophysical exploration, the method comprising:
accessing, from a data store, measured gravity values for a geographical area;
modeling gravity values for the geographical area;
determining gravity anomaly values based on the measured gravity values and the modeled gravity values;
generating a gravity anomaly map of the geographical area based on the determined gravity anomaly values and physical locations in the geographical area associated with the determined gravity anomaly values;
generating a dip surface representing inclinations of the geographical area based on the gravity anomaly map;
generating a gravity dip map of the geographical area by combining the dip surface with the gravity anomaly map; and
displaying, on a display device, a visual representation of the gravity dip map of the geographical area wherein colors of the visual representation represent the values of the gravity map.

2. The method of claim 1, further comprising:
determining a location within the geographical area to drill a well based on the gravity dip map; and
generating control commands to control remote drilling equipment to drill the well.

3. The method of claim 1, further comprising:
identifying locations of maximum curvature of the dip surface; and
generating a visual representation of lineaments of the geographical area based on the gravity dip map and the identified locations of maximum curvature of the dip surface.

4. The method of claim 3, further comprising:
determining locations within the geographical area to perform seismic exploration measurements based on the gravity dip map and the identified locations of maximum curvature.

5. The method of claim 1, wherein generating the gravity dip map is independent from applying high pass, band pass and low pass filters to the gravity anomaly map.

6. The method of claim 1, wherein generating a dip surface comprises scaling the gravity anomaly values based on a desired range of dip angles.

7. The method of claim 1, wherein the gravity anomaly values represent Bouguer gravity anomaly values.

8. A system for geophysical exploration, the system comprising:
at least one processor; and
a memory storing instructions that, when executed by the at least one processor, cause the at least one processor to perform operations comprising:
accessing, from a data store, measured gravity values for a geographical area;
modeling gravity values for the geographical area;
determining gravity anomaly values based on the measured gravity values and the modeled gravity values;
generating a gravity anomaly map of the geographical area based on the determined gravity anomaly values and physical locations in the geographical area associated with the determined gravity anomaly values;
generating a dip surface representing inclinations of the geographical area based on the gravity anomaly map;
generating a gravity dip map of the geographical area by combining the dip surface with the gravity anomaly map; and
displaying, on a display device, a visual representation of the gravity dip map of the geographical area wherein colors of the visual representation represent the values of the gravity map.

9. The system of claim 8, wherein the operations further comprise:
determining a location within the geographical area to drill a well based on the gravity dip map; and
generating control commands to control remote drilling equipment to drill the well.

10. The system of claim 9, wherein the operations further comprise:
identifying locations of maximum curvature of the dip surface; and
generating a visual representation of lineaments of the geographical area based on the gravity dip map and the identified locations of maximum curvature of the dip surface.

11. The system of claim 10, wherein the operations further comprise:
determining locations within the geographical area to perform seismic exploration measurements based on the gravity dip map and the identified locations of maximum curvature.

12. The system of claim 8, wherein generating the gravity dip map is independent from applying high pass, band pass and low pass filters to the gravity anomaly map.

13. The system of claim 8, wherein generating a dip surface comprises scaling the gravity anomaly values based on a desired range of dip angles.

14. The system of claim 8, wherein the gravity anomaly values represent Bouguer gravity anomaly values.

15. One or more non-transitory machine-readable storage devices storing instructions for geophysical exploration, the instructions being executable by one or more processors, to cause performance of operations comprising:
accessing, from a data store, measured gravity values for a geographical area;
modeling gravity values for the geographical area;
determining gravity anomaly values based on the measured gravity values and the modeled gravity values;
generating a gravity anomaly map of the geographical area based on the determined gravity anomaly values and physical locations in the geographical area associated with the determined gravity anomaly values;
generating a dip surface representing inclinations of the geographical area based on the gravity anomaly map;
generating a gravity dip map of the geographical area by combining the dip surface with the gravity anomaly map; and
displaying, on a display device, a visual representation of the gravity dip map of the geographical area wherein colors of the visual representation represent the values of the gravity map.

16. The non-transitory machine-readable storage devices of claim 15, wherein the operations further comprise:
determining a location within the geographical area to drill a well based on the gravity dip map; and
generating control commands to control remote drilling equipment to drill the well.

17. The non-transitory machine-readable storage devices of claim 15, wherein the operations further comprise:
identifying locations of maximum curvature of the dip surface; and
generating a visual representation of lineaments of the geographical area based on the gravity dip map and the identified locations of maximum curvature of the dip surface.

18. The non-transitory machine-readable storage devices of claim 17, wherein the operations further comprise:
determining locations within the geographical area to perform seismic exploration measurements based on the gravity dip map and the identified locations of maximum curvature.

19. The non-transitory machine-readable storage devices of claim 15, wherein generating the gravity dip map is independent from applying high pass, band pass and low pass filters to the gravity anomaly map.

20. The non-transitory machine-readable storage devices of claim 15, wherein generating a dip surface comprises scaling the gravity anomaly values based on a desired range of dip angles.
